(19) United States
(12) Patent Application Publication
(10) Pub. No.: US 2008/0301948 A1
(43) Pub. Date: Dec. 11, 2008

(54) Hair-Cutting Device for Self-Users

(75) Inventors: Johannes Kostner, Feldkirchen (AT); Peter Haefele, Unterbergen (AT); Drazen Stjepan Caric, Klagenfurt (AT)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., EINDHOVEN (NL)

(21) Appl. No.: 12/094,191

(22) PCT Filed: Nov. 20, 2006
(86) PCT No.: PCT/IB2006/054329

§ 371 Date: May 19, 2008

(30) Foreign Application Priority Data
Nov. 25, 2005 (EP) 05111300.9

(51) Int. Cl. B26B 19/28; B26B 21/52; B26B 19/00; B26B 15/00

(52) U.S. Cl. 30/42; 30/527; 30/199; 30/228

(57) ABSTRACT

To allow a self-user to conveniently position a cutting area to effectively and efficiently cut the hard to reach hair surface areas, a hair-cutting device (1) with a handle (40) and a cutting head (20) connected to the handle (40) is proposed, the cutting head (20) having one cutting unit (21) rotatably displaceable around an axis (R) of rotation, wherein the cutting area (27) and a point (P) on the axis (R) of rotation span a cutting plane (CP), the cutting plane (CP) being substantially perpendicular to the axis of rotation (R).

The present invention relates to a hair-cutting device with a handle and a cutting head connected to the handle, the cutting head having one cutting unit with one actual cutting area rotatably displaceable around an axis (R) of rotation, e.g. for trimming or clipping hair, in particular to trim or clip one's own hair.

Hair-cutting devices are widely used for cutting hair, especially for short haircuts and clipping hair around the ears or for trimming beards.

Generally used hair-cutting devices have a cutting unit with e.g. two blades moved relatively to one another with help of a motor. The cutting unit is normally mounted on a casing housing the motor or batteries as power supply for the hair-cutting device. To define a certain cut length, a comb unit may be mounted on the casing covering the cutting unit. The cut length is equivalent to the distance of the blades to the skin whereon the comb unit fixed on the casing is applied for cutting. To enlarge the range of usability of the clipping device, either different comb units having fins with various lengths and/or comb units adjustable with respect to the cutting unit are provided to allow for haircuts of different lengths.

Especially for non-professional users, who use a hair-cutting device to cut their own hair, there is in particular the need for different orientations of the cutting unit to conveniently reach the different regions of owns head or body, where one wants to cut hair.

Patent Application US 2002/0162226 A1 discloses a hair clipper having a pivoting clipper head. The hair clipper has a clipper head, a handle and connectors for connecting the handle and the head. The clipper head has a cutting assembly located thereon, the cutting assembly consisting of a stationary blade having teeth and a reciprocating blade having teeth, wherein the teeth of the stationary blade are substantially parallel to the teeth of the stationary blade forming a cutting edge. The handle has a longitudinal axis, a motor and a drive shaft driven by the motor. The connectors connect the clipper head and the handle such that the clipper head pivots about an axis of rotation that is perpendicular to the longitudinal axis of the handle and parallel to the cutting edge.

This hair clipper permits adjustment of the cutting assembly with respect to the handle to better enable the user to position the cutting assembly to more easily and effectively reach and maneuver the hair clipper with respect to the hard to reach hair surfaces. It has shown that the hair clipper according to the US 2002/0162226 A1 makes it somehow easier to cut hair of someone else. But if one wants to cut one's own hair, e.g. of one's neck, one still have to held the hair clipper in a quite unnatural position leading e.g. to an aching wrist and possibly leading to cutting mistakes.

It is thus an object of the present invention to provide a hair-cutting device allowing a self-user, too, to conveniently position a cutting area to effectively and efficiently cut the hard to reach hair surface areas.

This object is achieved by a hair-cutting device with a handle and a cutting head connected to the handle, the cutting head having one cutting unit with one actual cutting area rotatably displaceable around an axis of rotation, wherein the cutting area and a point on the axis of rotation span a cutting plane, the cutting plane being substantially perpendicular to the axis of rotation.

It has been found that allowing for different positions of the cutting area in the cutting plane with respect to the handle enables the user to much more conveniently use the hair-cutting device on himself, without the need of distorting his arm and hand as much as with conventional hair-cutting devices. Conventional hair-cutting devices are primarily designed to be used by one person on another person. Therefore their concept and ergonomics are optimized for that kind use. Technically speaking, the conventional use needs only one application direction.

If someone would like to use a hair-cutting device on him- or herself, the person tends to use his or her primary hand to do the complete haircut, even if the use at the opposite side is very inconvenient and straining. The hair-cutting device according to the present invention allows for different cutting directions with respect to the handle. For example, the cutting area may be rotated from one side of the handle to the other side of the handle, when changing from cutting hair on the back side to cutting hair on the front side or vice versa, but still holding the hair cutting device in the same hand with basically the same hand position. The hair-cutting device according to the present invention allows as well changing the position from holding the device with the primary hand to holding it with the secondary hand during a hair cut by providing the necessary cutting directions with respect to the handle. Especially self-users may always cut their hair against the hair's direction of growth, e.g. from the front to the back on the top of the head or upwards on the head's back, with a convenient hand position of the primary or the secondary hand.

Similarly, the orientation of the cutting area with respect to the handle may be changed to reach less accessible regions of the body, e.g. in the neck or the back of the person using the hair cutting device without straining the wrist and the elbow. The hair cutting device according to the present invention allows for cutting hair oneself, in particular one's own head by holding the hair cutting device in basically one position and adjusting the orientation of the cutting area by rotating it.

The cutting area not only defines the cutting plane, but generally defines the area of contact with the region of the body, where hair is to be cut, e.g. the head. The tangential plane through this area of contact with the body is basically equivalent to the cutting plane. The axis of rotation being substantially perpendicular to the cutting plane ensures that in all possible positions of the cutting area the angle between the cutting plane and the longitudinal axis of the handle is constant, thus improving the ease of use, in particular, but not only for self-users.

The described advantages are most pronounced, if the handle is not coplanar with the cutting plane. Preferably, the range of rotational angle is 0° to 360° to really allow for the optimal ease of use. The user is then free to choose the positions of the cutting area most appropriate to the region of the body, where hair is to be cut, and to his arm length and his agility.

In preferred embodiments of the present invention, the one cutting unit has disk-shaped blade means and cover means covering the disk-shaped blade means with exception of one segment defining the actual cutting area, the cover means being rotatable around the axis of rotation. These kinds of embodiments are particularly simple and inexpensively to realize, as only the rotatable cover means has to be added to a hair-cutting device with disk-shaped blade means.

In other preferred embodiments of the present invention, the cutting head is connected to the handle rotatably around the axis of rotation. These kinds of embodiments are particular advantageous for cutting units with two parallel and elongated blades, one of which is stationary and one of which is reciprocating—the most widely used cutting units in the state of the art. To change the direction of the cutting area with respect to the handle, the cutting head with cutting unit and cutting area is rotated. A further advantage of these kinds of embodiments is that they can easily be used together with comb units to define the cutting length.

Preferably, the cutting head contains a motor unit for driving the one cutting unit. This allows designing the hair-cutting device according to the invention to be compact and handy. Advantageously, in particular for embodiments with a rotatable cutting head, the axis of the motor unit is inclined with respect to the axis of rotation as well as to the longitudinal axis of the handle, i.e. the axis pointing from the end, where the device is held, to the end with cutting head or vice-versa. This does not only permit for even more compact hair-cutting devices, but also for an improved visibility of the cutting area, as the cutting unit may be arranged to protrude. Furthermore, contouring the hair cut around the ears or in the neck is easier with a protruding cutting unit.

Preferably, the angle between the axis of rotation and the longitudinal axis of the handle is less than 90°. This further improves the accessibility of difficult to reach areas, especially the region of the neck.

A detailed description of the invention is provided below. Said description is provided by way of a non-limiting example to be read with reference to the attached drawings in which:

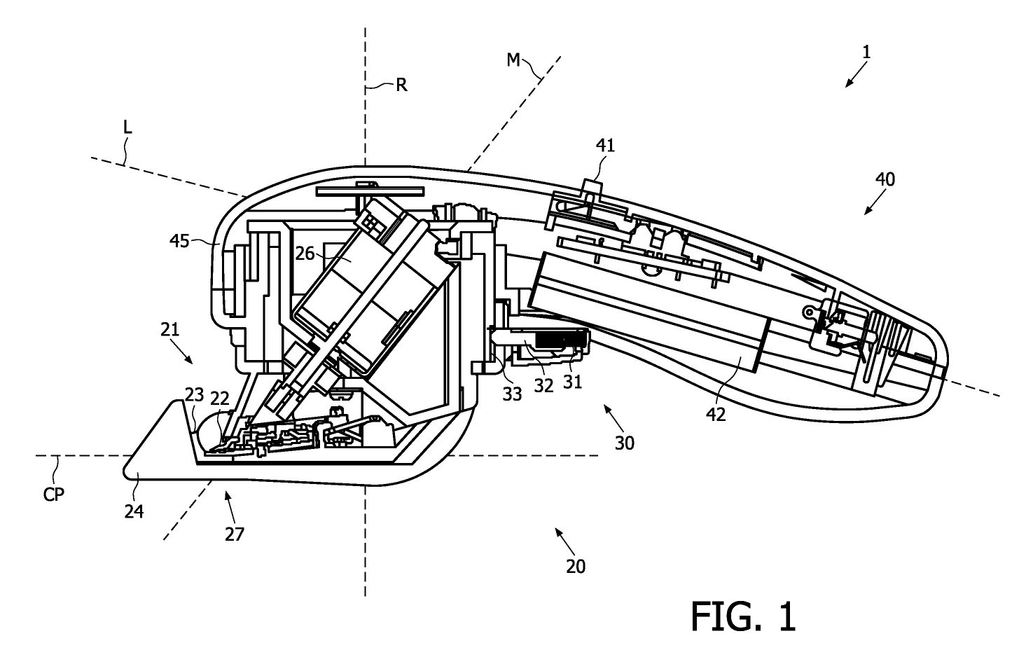

FIG. 1 is a cut view of a first embodiment of the present invention;

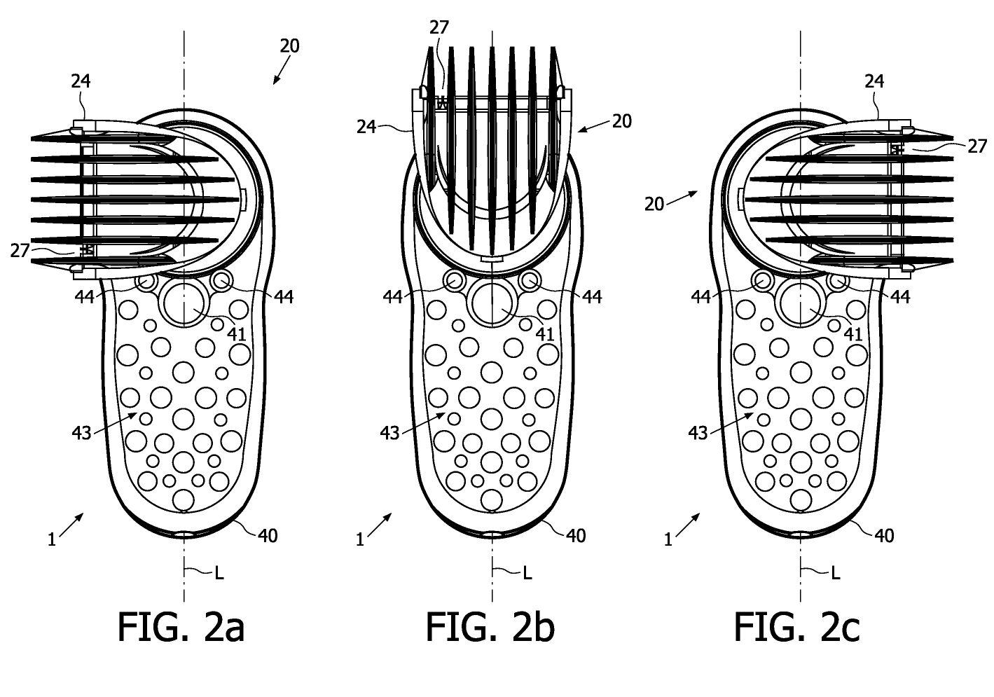

FIGS. 2a-c are plan views of the first embodiment of the present invention;

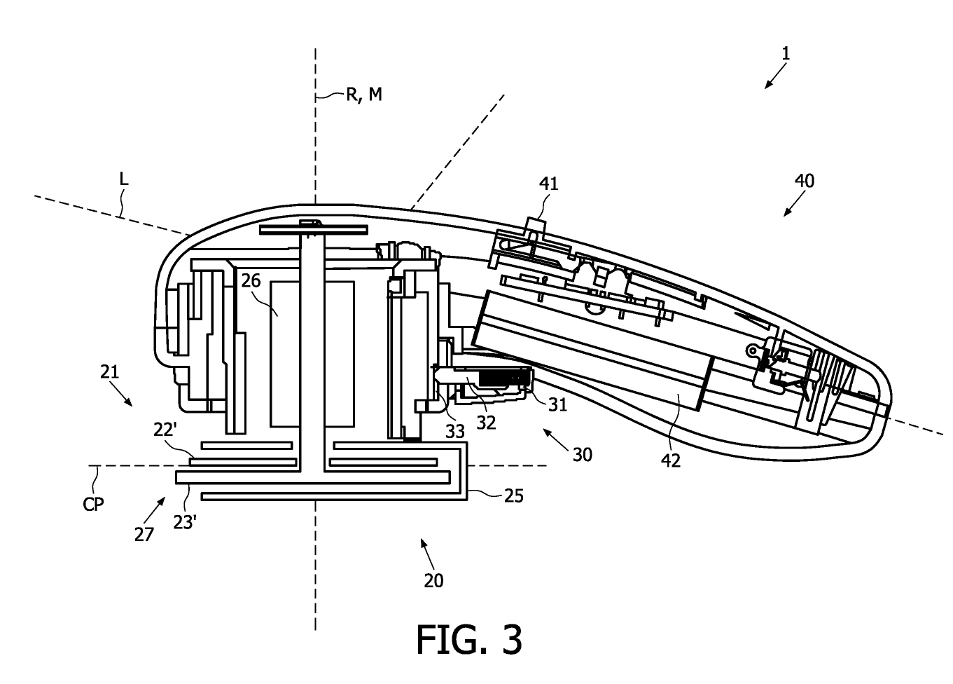

FIG. 3 is a cut view of a second embodiment of the present invention;

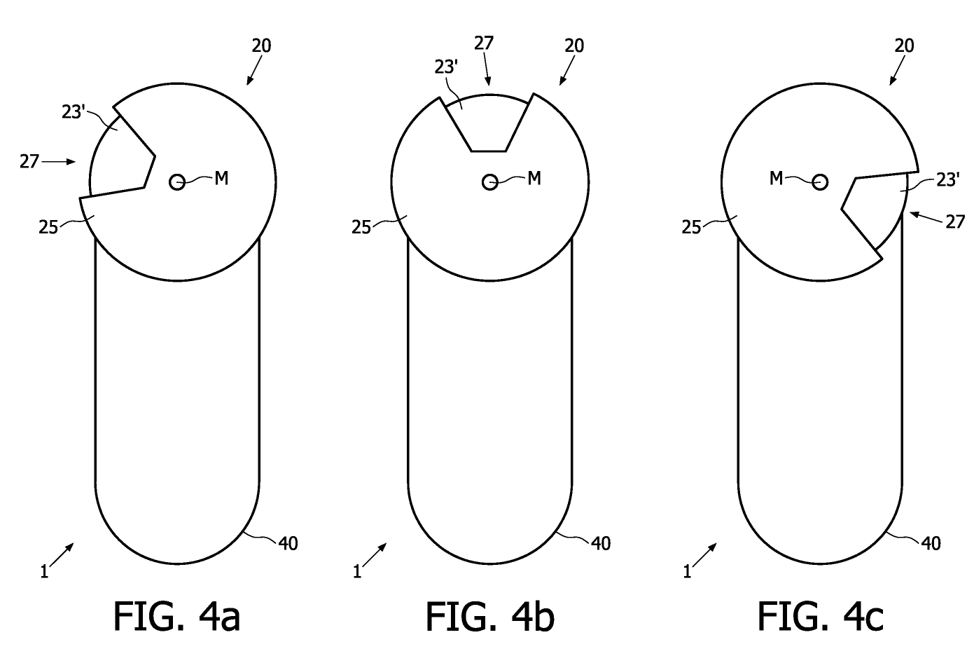

FIGS. 4a-c are plan views of the second embodiment of the present invention, and

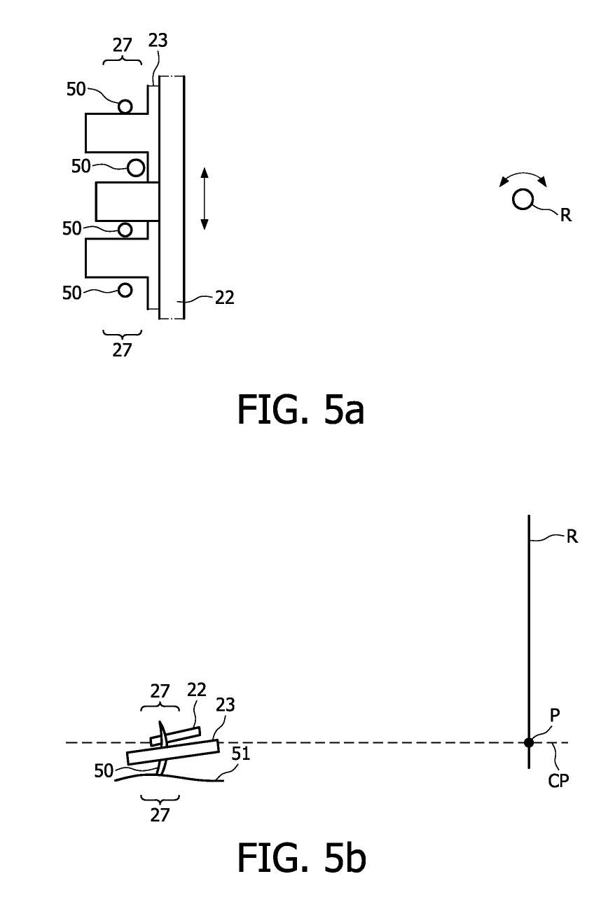

FIGS. 5a,b illustrate schematically the concept of the cutting plane in a top and a side view.

FIG. 1 illustrates a first embodiment of the hair-cutting device 1 according to the present invention. The hair-cutting device 1 has a handle 40 and a cutting head 20 connected to the handle 40. The cutting head 20 is rotatably connected to the handle 40 and can be rotated around the axis of rotation R. For maintenance such as cleaning or repairing, the cutting head 20 or only the cutting unit 21 may be removable.

The hair-cutting device 1 may be switched on and off by the switch 41 on the handle 40. The handle 40 houses a battery 42 to power the motor 26 driving the cutting unit 21. It will be noted that other means of powering the motor 26 are possible such as using an external power supply or a rechargeable battery.

The motor 26 drives the reciprocating blade 22 of the cutting unit 21, whereas the other blade 23 is stationary. Both blades 22, 23 are elongated and arranged in parallel. They have little teeth that do the actual cutting of hair stuck between them during the reciprocating action. The area where hair is exposed to the blades' teeth and cut is the cutting area 27.

The definition of the cutting plane CP with respect to the cutting area 27 and the axis R of rotation, respectively a point P on the axis R of rotation is schematically illustrated in FIGS. 5a,b. FIG. 5a shows the cutting area 27 and the axis R of rotation in a top view and FIG. 5b in a side view. A part of the reciprocating blade 22 is shown with one tooth between two teeth of a part of the stationary blade 23. The hair 50 in the interstices between the teeth of the stationary blade 23 and the tooth of the reciprocating blade 22 due to the reciprocating movement of the reciprocating blade 22 with respect to the stationary blade 23 by severing the hair 50 between the edges of the reciprocating and stationary teeth. The region, where hair 50 is actually cut, is the cutting area 27. Viewed in the context of the whole hair-cutting device, the cutting area 27 can be considered as line. This line and a point P on the axis R of rotation span the cutting plane CP (see FIG. 5b). The actual orientation of the blades 22, 23 is not relevant. The blades can be coplanar with cutting plane CP or inclined with respect to the cutting plane CP, as shown in FIG. 5b. Considered in the actual hair-cutting environment, the cutting plane CP is more or less equivalent to the plane tangential to the area of contact with the body region, e.g. the head 51, where hair 50 is to be cut.

Due to the inventive construction of having the axis of rotation R substantially perpendicular to the cutting plane CP, it is ensured that, despite of having various orientations of the cutting area 27, the angle of the cutting plane CP with respect to the longitudinal axis L of the handle 40 is always constant. This considerably enhances the ease of self-use without straining arm and hand holding the hair-cutting device 1 according to the present invention. The angle between the axis of rotation R and the longitudinal axis L is smaller than 90° to improve the usability of the hair-cutting device 1 in the neck and other quite difficult to reach areas of the body.

The hair-cutting device 1 illustrated in FIG. 1 is used in combination with a comb unit 24 to define the cut length and make the cutting more efficient by combing the hair. By combing, the hair is led more homogeneously and upright to the blades 22, 23 of the cutting unit 21. The comb unit 24 may be removable to be exchanged with another comb unit permitting another cut length. Some comb units allow for different cut length by moving the comb's fins with respect to the cutting unit 21.

The motor 26 is arranged in the cutting head 20. Its axis M is inclined with respect to the axis of rotation R and the longitudinal axis L of the handle 40. This has several advantages. The hair-cutting device 1 is very compact and allows for easy handling. The easy handling is further improved by having the center of gravity nearer to the actual cutting area 27. Furthermore, the cutting area 27 is slightly protruding with respect to the outer surface of the housing 45, thus improving visibility of the cutting area 27. This is useful, if a self-user utilizes a mirror to control the hair-cutting. Due to the protruding cutting area 27 contouring the hair cut e.g. around the ears or in the neck is made more convenient.

It will be noted that it would as well be possible to arrange the motor 26 in the handle 40. But then a traction mechanism for translating the driving power from the motor 26 to the cutting unit 21 would be necessary, making the construction of the hair-cutting device 1 more complex and expensive.

To secure the cutting head 20 in the desired position, a snapping mechanism 30 is provided. A protruding element 32 attached to the handle 40 via a spring 31 engages in recesses 33 arranged on the outer surface of the cutting head 20. Each recess corresponds to a certain position of the cutting head 20 with respect to the handle 40 and, thus, to a certain direction of the cutting area 27. The spring 31 is dimensioned to allow rotating the cutting head 20 without too much force, but still holding the protruding element 32 in the recess 33 during cutting. It will be noted that the snap mechanism 30 is only one of many various means known to the person skilled in the art for securing a given position of the cutting head 20 with respect to the handle 40.

FIGS. 2a-c show the hair-cutting device 1 of FIG. 1 in three exemplary positions of the cutting head 20, respectively of the cutting area 27. With respect to the longitudinal axis L of the handle 40, the cutting head 20 is rotated for +90° in FIG. 2a, for 0° in FIG. 2b and for −90° in FIG. 2c. Obviously, the cutting head 20 may be rotated into other positions, too, thus providing positions between −180° and 180°. In less sophisticated embodiments, only two, three, four etc. positions may be offered to the user. If the self-user is right-handed, he could for example use the hair-cutting device 1 with the cutting head 20 positioned as in FIG. 2a to cut hair on the right back side of his head from below to the top and with the cutting head 20 positioned as in FIG. 2c to cut hair on the right top side of his head from the front to the back without changing hand. In the same way, the self-user could use the hair-cutting device 1 with the cutting head 20 positioned as in FIG. 2a to cut hair from the back to the front with his right hand and with the cutting head 20 positioned as in FIG. 2c to cut hair from the back to the front with his left hand to cut against the direction of growth of the hair.

It will be noticed that the comb unit 24 shown in FIGS. 2a-c defines not only the cut length, but also the width of the cutting area 27. Only between the two most-left fins of the comb unit 24 are the blades with their teeth not covered. By using a comb unit with more areas uncovered, the width of the cutting area 27 can be chosen to be wider. Conventional comb units offering the whole width of the cutting area 27 may be used as well.

As shown in FIGS. 2a-c, the handle 40 has a grip area 43 that is not plane, but has several circular bumps, to avoid slipping of the hair-cutting device 1 out of the holding hand. Next to the On-/Off-switch 41 are two lamps 44 indicating, whether the hair-cutting device 1 is switched on or whether the battery needs to be changed or recharged. In other embodiments, there could be a button to automatically change the orientation of the cutting area 27, respectively of the cutting head 20, or to release a mechanism retaining the cutting head 20 in a desired position.

FIG. 3 shows another embodiment of the hair-cutting device 1 according to the present invention. The main differences to the embodiments described before are the different cutting unit 21 and the different arrangement of the motor 26.

This cutting unit 21 has disk-shaped blades 22′, 23′. Again, one blade 23′ is stationary and the other blade 22′ is reciprocating and is driven by the motor 26. The motor 26 is arranged in the cutting head 20 such that the motor axis M is basically the same as the axis of rotation R. The advantages of a compact and handy hair-cutting device 1 are still attained. If improved visibility is wished, this can be achieved by dimensioning the blades 22′, 23′ accordingly.

The cutting area 27 is defined by means of a cover means 25. The cover means 25 covers the blades 22′, 23′ with exception of a certain segment leaving access of the hair to the blades 22′, 23′. This area of free access to the blades 22′, 23′ is the cutting area 27.

This principle is more clearly illustrated in FIGS. 4a-c showing the hair-cutting device 1 in a plan view with three different exemplary positions of the cover means 25. By rotating the cover means 25 into any different positions, different areas on the whole circumference of the blades 22′, 23′ are defined as cutting area 27, each cutting area 27 having another cutting direction with respect to the handle 40. If desired, the cover means 25 may be design to be rotated only into some selected positions.

As in the embodiment shown in FIG. 1, the position of the cover means 25 may be secured by a snapping mechanism 30 (see FIG. 3) by connecting the cover means 25 to the outer surface of the cutting head 20 with the recesses 33.

Although having described several preferred embodiments of the invention, those skilled in the art would appreciate that various changes, alterations, and substitutions can be made without departing from the spirit and concepts of the present invention. The invention is, therefore, claimed in any of its forms or modifications with the proper scope of the appended claims. For example various combinations of the features of the following dependent claims could be made with the features of the independent claim without departing from the scope of the present invention. Furthermore, any reference numerals in the claims shall not be construed as limiting scope.

### LIST OF REFERENCE NUMERALS

1 hair-cutting device
20 cutting head
21 cutting unit
22, 22′ reciprocating blade
23, 23′ stationary blade
24 comb unit
25 cover means
26 motor
27 cutting area
30 snapping mechanism
31 spring
32 protruding element
33 recess
40 handle
41 switch
42 battery
43 grip
44 lamp
45 housing
50 hair
51 head
R axis of rotation
P point on axis of rotation
L longitudinal axis
CP cutting plane
M motor axis

1. A hair-cutting device with a handle and a cutting head connected to the handle, the cutting head having one cutting unit with one actual cutting area rotatably displaceable around an axis of rotation, characterized in that the cutting area and a point on the axis of rotation span a cutting plane, the cutting plane being substantially perpendicular to the axis of rotation.

2. The hair-cutting device according to claim 1, characterized in that the range of rotational angle is 0° to 360°.

3. The hair-cutting device according to claim 1, characterized in that the one cutting unit has disk-shaped blade means and cover means covering the disk-shaped blade means with exception of one segment defining the actual cutting area, the cover means being rotatable around the axis of rotation.

4. The hair-cutting device according to claim 1, characterized in that the cutting head is connected to the handle rotatably around the axis of rotation.

5. The hair-cutting device according to claim 1, characterized in that the cutting head contains a motor unit for driving the one cutting unit.

6. The hair-cutting device according to claim 5, characterized in that the axis of the motor unit is inclined with respect to the axis of rotation as well as to the longitudinal axis of the handle.

7. The hair-cutting device according to claim 1, characterized in that the angle between the axis of rotation and the longitudinal axis of the handle is less than 90°.
